(19) United States
(12) Patent Application Publication
(10) Pub. No.: US 2004/0165390 A1
(43) Pub. Date: Aug. 26, 2004

(54) Liquid crystalline polyester resin for reflector plate

(75) Inventors: Tomohiro Sato, Tsukuba-shi (JP); Hiroshi Nakamura, Tsuchiura-shi (JP)

Correspondence Address: FOLEY AND LARDNER, SUITE 500, 3000 K STREET NW, WASHINGTON, DC, 20007, US

(73) Assignee: SUMITOMO CHEMICAL COMPANY, LIMITED

(21) Appl. No.: 10/689,522

(22) Filed: Oct. 21, 2003

(30) Foreign Application Priority Data
Feb. 26, 2003 (JP) 2003-048945

(51) Int. Cl. F21V 7/00

(52) U.S. Cl. 362/341; 362/296

(57) ABSTRACT

There is provided a liquid crystalline polyester resin for a reflector plate having sufficient reflectance with respect to low wavelengths in visible light range. There is provided a liquid crystalline polyester resin for a reflector plate characterized by having a YI (Yellowness Index) value of 32 or less.

### FIELD OF THE INVENTION

The present invention relates to a liquid crystalline polyester resin for a reflector plate.

### BACKGROUND OF THE INVENTION

Reflector plates made of resins have been used for reflector plates of liquid crystal display devices from the viewpoint of a favorable processability and light weight thereof. Reflector plates are required to have a high reflectance with respect to all wavelengths in visible light range, and therefore metal plating is typically performed on the surface of the reflector plates; however, an additional process of metal plating is necessary for the process of producing a reflector plate. Therefore, reflector plates made of resins having high reflectance has been desired so that the additional process of metal plating is not required.

For example, a reflector plate obtained from a resin composition in which titanium oxide is mixed into liquid crystal polyester resin has been known as a reflector plate (JP No. 6-38520 A); however, reflectance is not sufficient with respect to low wavelengths in visible light range.

The object of the present invention is to provide a liquid crystalline polyester resin properly used for a reflector plate which has sufficient reflectance with respect to low wavelengths in visible light range.

### SUMMARY OF THE INVENTION

Through earnest studies for finding out a liquid crystalline polyester resin as described above, the inventors have completed the present invention by finding out that a liquid crystalline polyester resin having a YI (Yellowness Index) value of 32 or less is properly used for a reflector plate which has sufficient reflectance with respect to low wavelengths invisible light range.

The present invention provides a liquid crystalline polyester resin for a reflector plate having a YI (Yellowness Index) value of 32 or less.

### DETAILED DESCRIPTION OF PREFERRED EMBODIMENTS

A liquid crystalline polyester resin for a reflector plate of the present invention has a YI (Yellowness Index) value of 32 or less, preferably has a YI value of 32 or less and an L value of 75 or more, and more preferably has a YI value of 30 or less and an L value of 75 or more.

YI value and L value are values obtained by measuring a test piece of a liquid crystalline polyester resin with the use of a color difference meter.

YI value is an index denoting the yellowness of a substance and a value defined by ASTM D1925.

L value is an index denoting the lightness of a substance and a value defined by Hunter's color space.

L value and YI value are calculated in accordance with the following expression from X value, Y value and Z value measured according to JIS Z8722.

YI=[100(1.28X−1.06Z)/Y]

L=10Y^{1/2}

Wherein, X value, Y value and Z value are tristimulus values of light source color in XYZ color specification system respectively.

A liquid crystalline polyester resin of the present invention is polyester or polyester amide, named thermotropic liquid crystal polymer, which exhibits optical anisotropy in melting, and involves as follows:

(1) a resin comprising repeating units derived from one kind, or two or more kinds of aromatic hydroxycarboxylic acid,

(2) a resin comprising a combination of repeating units derived from aromatic dicarboxylic acid and aromatic diol,

(3) a resin comprising a combination of repeating units derived from aromatic hydroxycarboxylic acid, aromatic dicarboxylic acid and aromatic diol,

(4) a polyester resin obtained by reacting polyethylene terephthalate is reacted with aromatic hydroxycarboxylic acid,

(5) a resin in which a part of repeating units derived from aromatic hydroxycarboxylic acid and aromatic diol described in the above-mentioned (1) to (4) is substituted with repeating units derived from aromatic aminocarboxylic acid, aromatic hydroxyamine and aromatic diamine,

and the like, and forms anisotropic melt at a temperature of 400° C. or less.

In addition, instead of these aromatic hydroxycarboxylic acid, aromatic dicarboxylic acid, aromatic diol, aromatic aminocarboxylic acid, aromatic hydroxyamine and aromatic diamine, an ester-forming derivative or an amide-forming derivative thereof may be employed.

A repeating unit of the liquid crystalline polyester includes the following.

A repeating unit derived from aromatic hydroxycarboxylic acid:

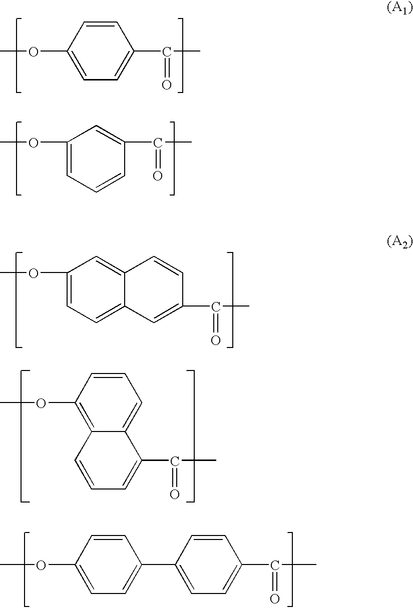

The above-mentioned repeating unit may be substituted with a halogen atom, an alkyl group or an aryl group.

A repeating unit derived from aromatic dicarboxylic acid:

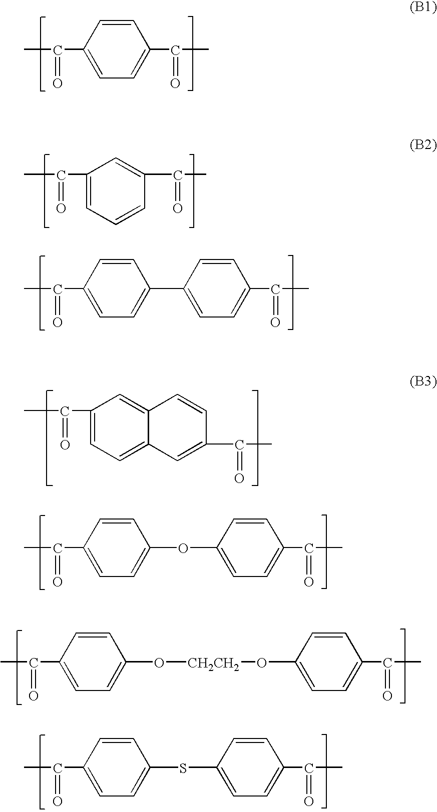

The above-mentioned repeating unit may be substituted with a halogen atom, an alkyl group or an aryl group.

A repeating unit derived from aromatic diol:

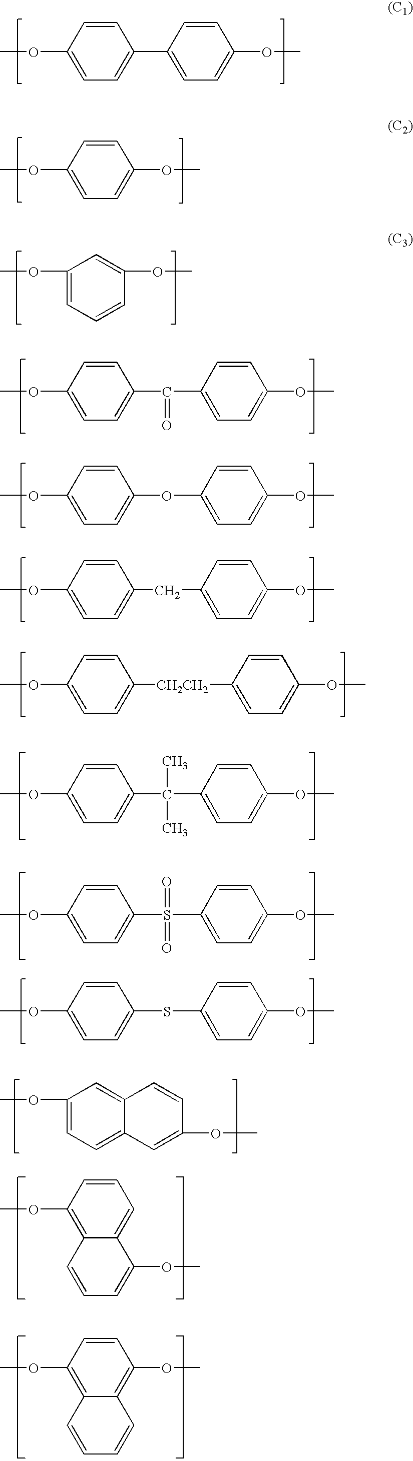

The above-mentioned repeating unit may be substituted with a halogen atom, an alkyl group or an aryl group.

A repeating unit derived from aromatic aminocarboxylic acid:

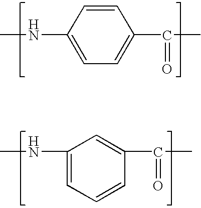

The above-mentioned repeating unit may be substituted with a halogen atom, an alkyl group or an aryl group.

A repeating unit derived from aromatic hydroxyamine and aromatic diamine:

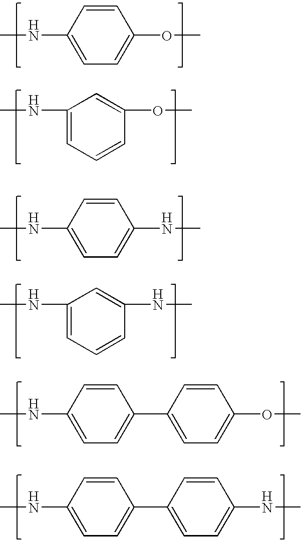

The above-mentioned repeating unit may be substituted with a halogen atom, an alkyl group or an aryl group.

The halogen atom as a substituent in each of the above-mentioned repeating units includes a fluorine atom, a chlorine atom, a bromine atom and an iodine atom.

The alkyl group includes an alkyl group with a carbon number of 1 to 6 such as a methyl group and an ethyl group.

The aryl group includes an aryl group with a carbon number of 6 to 20 such as a phenyl group and a naphthyl group.

The liquid crystalline polyester preferably contains at least 30 mol % of a repeating unit represented in the above-mentioned (A₁) in view of the balance of heat resistance, mechanical properties and processability.

More preferably, a combination of repeating units includes the following combination of (a) to (f).

(a): a combination of (A₁), (B₁), and (C₁), or a combination of (A₁), a mixture of (B₁) and (B₂), and (C₁).

(b): a combination of (A₁) and (A₂)

(c): a combination (a) in which a part of (A₁) is replaced with (A₂)

(d) a combination (a) in which a part of (B₁) is replaced with (B₃)

(e): a combination (a) in which a part of (C₁) is replaced with (C₃)

(f): a combination (b) to which (B₁) and (C₂) are added

A liquid crystalline polyester resin of the present invention, for example, the liquid crystalline polyester resin comprising above mentioned (a) or (b) are produced by a reaction described in JP No. 47-47870 B, JP No. 63-3888 B and the like.

The producing method includes a method such that a mixture of aromatic hydroxycarboxylic acid, aromatic diol and aromatic dicarboxylic acid is mixed with fatty acid anhydride, and a hydroxyl group of aromatic hydroxycarboxylic acid and aromatic diol is reacted with fatty acid anhydride in an atmosphere of nitrogen at a temperature of 130 to 180° C. to be acylated, and thereafter transesterifcation or polycondensation is carried out while evaporating a by-product of the reaction out of the reaction system by heating.

The ratio of a hydroxyl group to a carboxyl group in the mixture of aromatic hydroxycarboxylic acid, aromatic diol and aromatic dicarboxylic acid is preferably from 0.9 to 1.1.

The amount of fatty acid anhydride is preferably 0.95 to 1.2-times equivalent weight with respect to a hydroxyl group of aromatic hydroxycarboxylic acid and aromatic diol, more preferably 1.00 to 1.12-times equivalent weight, and much more preferably 1.00 to 1.05-times equivalent weight from the viewpoint of decreasing YI value and increasing L value.

The fatty acid anhydride includes, for example acetic anhydride, propionic anhydride, butyric anhydride, isobutyric anhydride, a mixture of these, and butyric anhydride is preferably used from the viewpoint of costs and handling. Also, propionic anhydride and butyric anhydride are preferably used from the viewpoint of decreasing YI value and is creasing L value.

The above-mentioned acylation may be performed in the presence of a conventional catalyst.

The transesterification (or polycondensation) is preferably carried out while heating at a rate of 0.1 to 50° C./minute in a temperature range of 130 to 400° C., more preferably at a rate of 0.3 to 5° C./minute in a temperature range of 150 to 350° C.

The transesterification is preferably carried out in the presence of a heterocyclic organic basic compound containing two or more nitrogen atoms from the viewpoint of decreasing YI value and increasing L value.

The heterocyclic organic basic compound containing two or more nitrogen atoms includes, for example, an imidazole compound, a triazole compound, a dipyridylyl compound, a phenanthroline compound, a diazaphenanthrene compound. Among these, an imidazole compound is preferably used from the viewpoint of reactivity, and 1-methylimidazole and 1-ethylimidazole are more preferably used in view of easy availability.

The transesterification (or polycondensation) is preferably carried out by evaporating a by-product of the reaction out of the system.

A method of further progressing the transesterification (or polycondensation) to improve the degree of polymerization includes a method such as to decompress the inside of a reactor container for the transesterification (or polycondensation), a method such that a reaction product after being solidified by cooling is ground into a powdery state so as to polymerize the obtained powder in the solid phase at a temperature of 250 to 350° C. for 2 to 20 hours. The solid-phase polymerization is preferably performed under an atmosphere of nitrogen from the viewpoint of increasing YI value and decreasing L value.

A liquid crystalline polyester resin of the present invention is preferably made into a liquid crystalline polyester resin composition by mixing titanium oxide from the viewpoint of improving reflectance.

The mixed amount of titanium oxide in the resin composition is preferably 5 to 100 parts by weight with respect to 100 parts by weight of a liquid crystalline polyester resin, more preferably 10 to 80 parts by weight, and much more preferably 20 to 60 parts by weight. The mixed amount of less than 5 parts by weight may not be effective on reflectance of a reflector plate obtained from the resin composition, while the mixed amount of more than 100 parts by weight may effect on productivity in granulating process, or a reflector plate obtained from the resin composition may have lower strength due to degradation of a liquid crystalline polyester by mixing high amount of titanium oxide.

Titanium oxide is not particularly limited; titanium oxide of a rutile type, an anatase type and a mixed type of both can be used. A rutile type of titanium oxide is preferably used from the viewpoint of reflectance and weather resistance.

The particle diameter of titanium oxide also is not particularly limited; from the viewpoint of reflectance and dispersibility, the average particle diameter thereof is preferably 0.01 to 10 μm, more preferably 0.1 to 1 μm, and much more preferably 0.1 to 5 μm.

Titanium oxide may be subjected to surface-treat. Titanium oxide surface-treated with inorganic metal oxide is preferably used from the viewpoint of dispersibility and weather resistance, and alumina is preferable as the inorganic metal oxide.

A method of surface-treating is not particularly limited; a known method can be employed.

A white pigment except titanium oxide, such as zinc oxide, zinc sulfide and white lead, may be added to a liquid crystalline polyester resin composition of the present invention, from the viewpoint of improving reflectance.

Also, filler except titanium oxide may be added to a liquid crystalline polyester resin composition of the present invention.

In this case, the added amount of filler including titanium oxide is preferably 5 to 150 parts by weight with respect to 100 parts by weight of a liquid crystalline polyester resin, more preferably 10 to 100 parts by weight. When the large amount is added the melting viscosity of the resin composition may increase, leading to a deterioration in granulativity and moldability.

The filler except titanium oxide includes inorganic fiber such as glass fiber, carbon fiber, metal fiber, alumina fiber, boron fiber, titanic acid fiber and asbestos, powder such as calcium carbonate, alumina, aluminum hydroxide, kaolin, talc, clay, mica, glass flakes, glass bead, hollow glass bead, quartz sand, silica sand, wollastonite, dolomite, various metal powders, carbon black, graphite, barium sulfate, potassium titanate and calcined plaster, powdery, platy and whiskery inorganic compound such as silicon carbide, alumina, boron nitride, aluminum borate and silicon nitride, woody powder such as wood flour, coconut shell flour, walnut flour and pulp flour, and the like.

Among these, glass fiber, glass flakes, glass bead, hollow glass bead and talc are preferably used from the viewpoint of mechanical properties and reflectance.

Further, at least one kind of a usual additive, such as a release improving agent, for example, fluororesin and metal soaps; a coloring agent, for example, dyestuff and pigment; an antioxidant; a thermal stabilizer; an ultraviolet absorbing agent; an antistatic agent; and a surface active agent, may be added to a liquid crystalline polyester resin composition within a range of no deterioration in the object of the present invention. Also, at least one kind of an agent having the effect of an external slip additive may be added thereto, such as a higher fatty acid, a higher fatty acid ester, a higher fatty acid metallic salt and a fluorocarbon-based surface active agent.

Further, at least one kind of a thermoplastic resin such as polyethylene, polyamide, polyester, polyphenylene sulfide, polyether ketone, polycarbonate, polyphenylene ether and a modified product thereof, polysulfone, polyether sulfone and polyether imide, a thermosetting resin such as phenolic resin, epoxy resin and polyimide resin, and the like may be added thereto.

A method of preparing a liquid crystalline polyester resin composition is not particularly limited; including a method of preparing by separately supplying for a melting mixer a liquid crystalline polyester resin, titanium oxide, a white pigment and a filler except titanium oxide if required and the like, a method of preparing by premixing these raw material components with a mortar, a Henschel mixer, a ball mill, a ribbon blender and the like to supply them for a melting mixer, and the like.

A reflector plate can be obtained by molding a liquid crystalline polyester resin composition thus obtained.

A molding method includes an injection molding method, an injection compression molding method, an extrusion method and the like.

The molding temperature is preferably a higher temperature by 10 to 60° C. than the flow temperature of a liquid crystalline polyester resin composition. A lower molding temperature than the above-mentioned temperature may deteriorate flowability and cause a deterioration in moldability and a fall in the strength of a reflector plate, while a higher molding temperature than the above-mentioned temperature may cause degradation of the resin and decrease in the reflectance of a reflector plate.

A flow temperature means a temperature at which a melting viscosity shows 4800 Pa-sec on the condition that a resin heated at a heating rate of 4° C./minute is extruded from a nozzle having an inside diameter of 1 mm and a length of 10 mm under a load of 9.8 MPa.

A liquid crystalline polyester resin for a reflector plate of the present invention is superior in heat resistance, flowability and mechanical strength as well as reflectance with respect to low wavelengths invisible light range. In the present invention, low wavelengths invisible light range usually signify 400 to 500 nm.

Therefore, the reflector plate comprising the liquid crystalline polyester resin is preferably used for a reflector plate of electronic and electric appliances such as Light Emitting Diode (LED). The reflector plate is used more preferably for a reflector plate for blue or white LED. Further, the LED comprising the reflector plate is preferably used for a backlight of liquid crystalline display.

The present invention is hereinafter described by using examples.

The measurement of various physical properties in examples was performed by using the following manner.

(1) L Value and YI Value

To the surface of a test piece having a size of 64 mm×64 mm×1 mm comprising a liquid crystalline polyester resin obtained in each of examples and comparative examples, the measurement thereof was performed by using a calorimetric color difference meter (ZE-2000: manufactured by NIPPON DENSHOKU INDUSTRIES CO., LTD.).

(2) Reflectance

To the surface of a test piece having a size of 64 mm×64 mm×1 mm comprising a liquid crystalline polyester resin composition obtained in each of examples and comparative examples, the measurement of diffuse reflectance of light with each wavelength in visible light range was performed by using an autographic spectrophotometer (U-3500: manufactured by Hitachi, Ltd.). The reflectance is a relative value to the diffuse reflectance (100%) of a standard whiteboard of barium sulfate.

### EXAMPLE 1

994.5 g (7.2 mol) of para-hydroxybenzoic acid, 446.9 g (2.4 mol) of 4,4′-dihydroxybiphenyl, 299.0 g (1.8 mol) of terephthalic acid, 99.7 g (0.6 mol) of isophthalic acid and 1347.6 g (13.2 mol) of acetic anhydride were charged into a reaction vessel provided with a stirrer, a torque meter, a nitrogen gas introduction pipe, a thermometer and a reflux cooler to add 0.2 g of 1-methylimidazole thereto. After being sufficiently replaced with nitrogen gas in the reaction vessel, the inside thereof was heated to 150° C. in 30 minutes under nitrogen gas airflow to be maintained at the temperature and refluxed for 1 hour.

Then, after adding 1.8 g of 1-methylimidazole, the inside thereof was heated to a temperature of 320° C. in 2 hours and 50 minutes while evaporating distilling by-produced acetic acid and unreacted acetic anhydride so as to be regarded as the completion of the reaction at the point of time when the rise of torque was observed, and the contents were taken out. The obtained solid body was cooled to room temperature and ground by a rough grinder to be thereafter heated from room temperature to 250° C. in 1 hour under nitrogen gas atmosphere and additionally heated from 250° C. to 285° C. in 5 hours and then maintained at a temperature of 285° C. for 3 hours, and the solid-phase polymerization was progressed. The obtained liquid crystalline polyester resin had a flow temperature of 327° C., an L value of 79.8 and a YI value of 26.6.

100 parts by weight of the obtained liquid crystalline polyester resin was mixed with 50 parts by weight of glass fiber (EFH75-01 manufactured by CENTRAL GLASS CO., LTD.) and 17 parts by weight of titanium oxide (CR-60 manufactured by ISHIHARA SANGYO KAISHA, LTD.), and thereafter granulated by using the double-screw extruder (PCM-30 manufactured by IKEGAI TEKKOU CO., LTD.) at a cylinder temperature of 340° C. so as to obtain a liquid crystalline polyester resin composition. The obtained liquid crystalline polyester resin composition was molded by the injection molder (PS40E5ASE type manufactured by NISSEI PLASTIC INDUSTRIAL CO., LTD.) at a temperature of 350° C. to obtain a flat-plate test piece having a size of 64 mm×64 mm×1 mm for measuring the reflectance. The results are shown in Table 1.

### COMPARATIVE EXAMPLE 1

A liquid crystalline polyester resin was obtained through the polymerization in the same manner as Example 1 except for not adding 1-methylimidazole in acylating and transesterification. The obtained liquid crystalline polyester resin had a flow starting temperature of 326° C., an L value of 75.6 and a YI value of 34.5.

Further, a liquid crystalline polyester resin composition molded product was obtained in the same manner as Example 1 with respect to the obtained liquid crystalline polyester resin so as to measure a reflectance thereof. The results are shown in Table 1.

### EXAMPLE 2

A liquid crystalline polyester resin was obtained through the polymerization in the same manner as Example 1 except for changing the monomer constitution charged into a reaction vessel to 994.5 g (7.2 mol) of para-hydroxybenzoic acid, 446.9 g (2.4 mol) of 4,4′-dihydroxybiphenyl, 358.8 g (2.2 mol) of terephthalic acid, 39.9 g (0.2 mol) of isophthalic acid and 1347.6 g (13.2 mol) of acetic anhydride, and changing the maintenance temperature of the solid-phase polymerization to a temperature of 310° C. The obtained liquid crystalline polyester resin had a flow starting temperature of 360° C., an L value of 77.3 and a YI value of 27.9.

Further, a liquid crystalline polyester resin composition molded product was obtained in the same manner as Example 1 except for changing the granulation temperature to a temperature of 370° C. and changing the molding temperature to a temperature of 380° C. with respect to the obtained liquid crystalline polyester resin so as to measure a reflectance thereof. The results are shown in Table 1.

### COMPARATIVE EXAMPLE 2

A liquid crystalline polyester resin was obtained through the polymerization in the same manner as Example 2 except for not adding 1-methylimidazole in acylating and transesterification. The obtained liquid crystalline polyester resin had a flow starting temperature of 360° C., an L value of 72.3 and a YI value of 42.3.

Further, a liquid crystalline polyester resin composition molded product was obtained in the same manner as Example 2 with respect to the obtained liquid crystalline polyester resin so as to measure a reflectance thereof. The results are shown in Table 1.

### EXAMPLE 3

A liquid crystalline polyester resin was obtained through the polymerization in the same manner as Example 1 except for changing the monomer constitution charged into a reaction vessel to 1210.0 g (8.8 mol) of para-hydroxybenzoic acid, 609.7 g (3.2 mol) of 2,6-hydroxynaphthoic acid and 1347.6 g (13.2 mol) of acetic anhydride, and changing the maintenance temperature of the solid-phase polymerization to a temperature of 270° C. The obtained liquid crystalline polyester resin had a flow starting temperature of 290° C., an L value of 79.8 and a YI value of 27.4.

Further, a liquid crystalline polyester resin composition molded product was obtained in the same manner as Example 1 except for changing the granulation temperature to a temperature of 310° C. and changing the molding temperature to a temperature of 320° C. with respect to the obtained liquid crystalline polyester resin so as to measure a reflectance thereof. The results are shown in Table 1.

TABLE 1

| | Flow | | | Reflectance (%) | | | |
|---|---|---|---|---|---|---|---|
| | Temperature | L | YI | 450 | 500 | 600 | |
| | (° C.) | Value | Value | nm | nm | nm | 700 nm |
| Example 1 | 327 | 79.8 | 26.6 | 71.8 | 75.6 | 80.9 | 83.8 |
| Example 2 | 360 | 77.3 | 27.9 | 67.4 | 71.7 | 76.8 | 80.1 |
| Example 3 | 290 | 79.8 | 27.4 | 71.3 | 76.3 | 80.4 | 82.7 |
| Comparative | 326 | 75.6 | 34.5 | 63.9 | 71.6 | 78.2 | 81.5 |
| Example 1 | | | | | | | |
| Comparative | 360 | 72.3 | 42.3 | 61.1 | 68.7 | 76.1 | 79.7 |
| Example 2 | | | | | | | |

The present invention provide a liquid crystalline polyester resin used for a reflector plate having sufficient reflectance with respect to low wavelengths in visible light range.

What is claimed is:

1. A liquid crystalline polyester resin for a reflector plate, wherein a YI (Yellowness Index) value is 32 or less.

2. A resin according to claim 1, wherein an L value is 75 or more.

3. A liquid crystalline polyester resin composition for a reflector plate comprising:
a resin according to claim 1; and
titanium oxide.

4. A reflector plate comprising the liquid crystalline polyester resin according to claim 1.

5. A reflector plate comprising the liquid crystalline polyester resin composition according to claim 3.

6. The reflector plate according to claim 4 or 5, wherein the reflector plate is obtained by injection-molding.

7. A light emitting diode comprising the reflector plate according to claim 4 or 5.

8. The light emitting diode according to claim 7, wherein the light emitting diode is blue light emitting diode.

9. The light emitting diode according to claim 7, wherein the light emitting diode is white light emitting diode.

10. A backlight comprising the light emitting diode according to claim 7.
